(19) United States
(12) Patent Application Publication
(10) Pub. No.: US 2006/0280546 A1
(43) Pub. Date: Dec. 14, 2006

(54) APPARATUS FOR DISPENSING LIQUID

(76) Inventor: John J. Dyer, Shoreview, MN (US)

Correspondence Address: 3M INNOVATIVE PROPERTIES COMPANY, PO BOX 33427, ST. PAUL, MN, 55133-3427, US

(21) Appl. No.: 11/423,798

(22) Filed: Jun. 13, 2006

Related U.S. Application Data
(60) Provisional application No. 60/690,290, filed on Jun. 14, 2005.

(51) Int. Cl. A47L 13/30; A47L 13/00; B43M 11/06

(52) U.S. Cl. 401/139; 401/138; 401/137; 401/184

(57) ABSTRACT

The present invention provides a liquid dispensing mop in which the fluid reservoir is disposed on or adjacent a handle at or above the midpoint of the handle. In some embodiments, the reservoir is disposed on or adjacent the upper end of the handle and is coaxially aligned with the long axis of the handle.

### PRIORITY CLAIM

This application claims priority to provisional application Ser. No. 60/690,290 filed on Jun. 14, 2005.

### FIELD OF THE INVENTION

The present disclosure relates to a mop or similar cleaning implement. More particularly, the disclosure relates to a liquid dispensing mop having a fluid reservoir disposed on or adjacent the handle.

### BACKGROUND

Mop assemblies of the type used for applying liquids (e.g., water, cleaning solutions, floor wax, disinfectants, etc.) to a floor surface commonly include a mop head, a handle by which the mop head can be manually moved along the surface, and a reservoir containing the liquid. The reservoir is usually connected to a nozzle or dispensing tube situated near the mop head so that liquid can be deposited onto the mop head or onto the floor surface at a position close to the mop head to facilitate application of the liquid over the floor surface. The flow of liquid from the reservoir is typically controlled by a valve, which is normally closed to stop the flow of liquid through the valve, but can be manually opened to allow liquid from the container to flow through the valve. The valve is generally actuated by the mop user in order to permit dispensing of the liquid at a time and place optimal for liquid usage efficiency. One advantage of such liquid dispensing mop assemblies is that there is no need for the mop operator to apply the liquid to the surface in a separate step—it can be done as part of the mopping operation, thereby increasing the efficiency of the mopping process.

In many conventional liquid dispensing mop assemblies, the reservoir is disposed on or adjacent the handle, typically low on the handle, just above the mop head. Although this makes for convenient location of the reservoir, it increases the weight and bulkiness of the mop, making it more difficult and tiring to use since the weight of the reservoir and liquid must be overcome when swinging or pushing the mop during normal use. Some mop assemblies attempt to avoid these problems by separating the reservoir from the mop handle so that the reservoir does not have to be moved back and forth with the handle during the mopping process; however, such systems can be cumbersome and awkward to manipulate as the connection between the reservoir and the dispensing tube can interfere with use of the mop. Therefore, improvements are desirable.

### SUMMARY

This disclosure concerns a liquid dispensing cleaning apparatus in which the fluid reservoir is disposed on or adjacent the upper end of the handle and can be manually grasped and manipulated as part of the handle. The apparatus, cleaning system, and the method of cleaning avoid many of the shortcomings of conventional mop-like cleaning systems. Accordingly, in one embodiment of the present disclosure liquid dispensing mop in which a liquid reservoir is disposed on or adjacent the handle substantially at or above the midpoint of the handle is provided. In certain embodiments, the reservoir is disposed on or adjacent the upper end of the handle and is coaxially aligned with the long axis of the handle.

In another aspect, the present disclosure provides a liquid dispensing mop in which a liquid reservoir is deformable and/or squeezable and is disposed on or adjacent the handle so that the reservoir may be manually grasped as part of the handle during usage of the mop. A system is provided that includes the cleaning apparatus, bottles of cleaning fluid, and a holster for carrying the bottles. In addition, a new method of cleaning is provided according to the disclosure.

### BRIEF DESCRIPTION OF DRAWINGS

FIG. 1 is a perspective view of a first embodiment of an inventive liquid dispensing mop.

FIG. 2a is a perspective view of the reservoir holder of FIG. 1.

FIG. 2b is a perspective view of a second embodiment of the reservoir holder of FIG. 2a.

FIG. 3 shows a locking tab used to hold the fluid reservoir inside the reservoir holder shown in FIG. 2b.

FIG. 4 is a perspective exploded view of an exemplary fluid outlet adapter of FIG. 1.

FIGS. 5a and 5b are diagrammatic views of alternative embodiments of an inventive liquid dispensing mop.

FIGS. 6a-d are side views of four exemplary alternative embodiments of bottle and shaft configurations according to the disclosure.

FIG. 7a is an exploded perspective view of a third alternative embodiment of the reservoir holder and bottle of FIG. 1.

FIG. 7b is a perspective view of the reservoir holder of FIG. 7a with a bottle therein.

FIG. 7c is a cross-sectional view of the reservoir holder of FIG. 7b.

FIG. 8 is an exploded view of a fourth embodiment of the reservoir holder of FIG.

FIG. 9 is a perspective view of an alternative embodiment of the bottle of FIG. 1.

FIG. 10a is an exploded view of a fifth embodiment of the reservoir holder of FIG. 1.

FIG. 10b is a perspective view of the reservoir holder of FIG. 10a, with the door in an open position.

FIG. 10c is a perspective view of the reservoir holder of FIG. 10a, with the door in a closed position.

FIG. 11 is a perspective view of a sixth embodiment of the reservoir holder and bottle of FIG. 1.

FIG. 12 is a perspective view of a seventh embodiment of the reservoir holder and bottle of FIG. 1.

FIG. 13 is a perspective view of a bottle holster according to the present disclosure.

FIG. 14a is a perspective view of a telescoping shaft according to the disclosure.

FIG. 14b is a cross-sectional view of a telescoping shaft according to the present disclosure.

While the above-identified drawing figures set forth one or more embodiments of the disclosure, other embodiments are also contemplated as noted in the discussion. In all cases, this disclosure presents the present invention by way of representation and not limitation. It should be understood that numerous other modifications and embodiments can be devised by those skilled in the art which fall within the spirit and scope of the principles of this disclosure.

### DETAILED DESCRIPTION

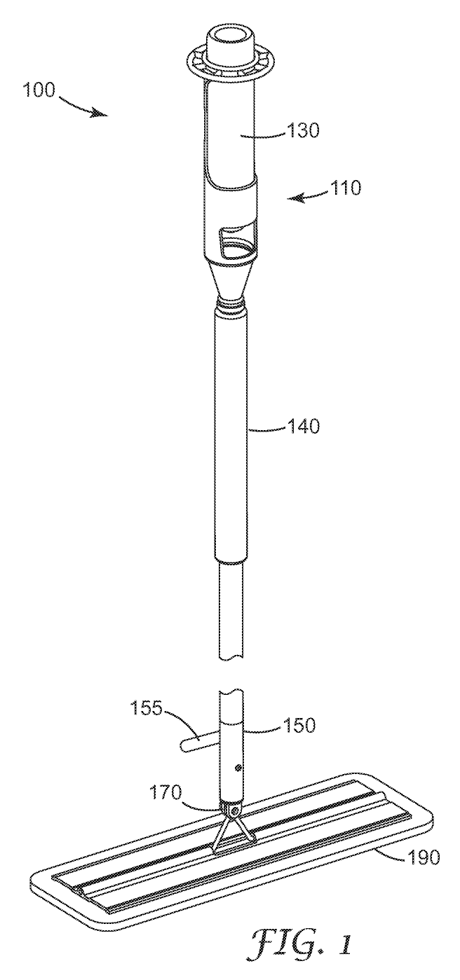

FIG. 1 depicts an exemplary mop assembly 100 according to one aspect of the instant disclosure. A mop handle 140 is adapted on its lower end to receive a portion of a fluid dispense assembly 150. The mop handle 140 is also adapted on its upper end to receive a portion of a reservoir assembly 110. A mop head 190 is coupled to the fluid dispensing assembly by means of a coupling joint 170. In the embodiment depicted, the fluid reservoir 130 is a bottle and the mop handle 140 comprises a hollow tube. In use, a fluid such as water, cleaning solution, floor wax or the like is conveyed from the reservoir assembly 110 to the floor via the hollow handle 140 into the fluid dispense assembly 150 exiting through the fluid dispense spout 155 to be deposited on the floor in proximity to the mop head 190. The fluid may then be spread about on the floor or any other surface in typical mopping fashion.

In the instant disclosure, the reservoir assembly 110 is typically disposed above the midpoint of the mop handle 140. In a preferred embodiment, the reservoir assembly 110 of the liquid dispensing mop 100 is disposed at the upper end of the handle with the long axis of the reservoir assembly 110 being coaxial with the long axis of the handle 140 as depicted in FIG. 1. In this configuration, for example, the reservoir may serve as an extension of the mop handle and may also be manually squeezed or otherwise manipulated by the operator without significant release of the handle or changing of hand positions to effect dispensing of the fluid from the reservoir onto the surface to be cleaned.

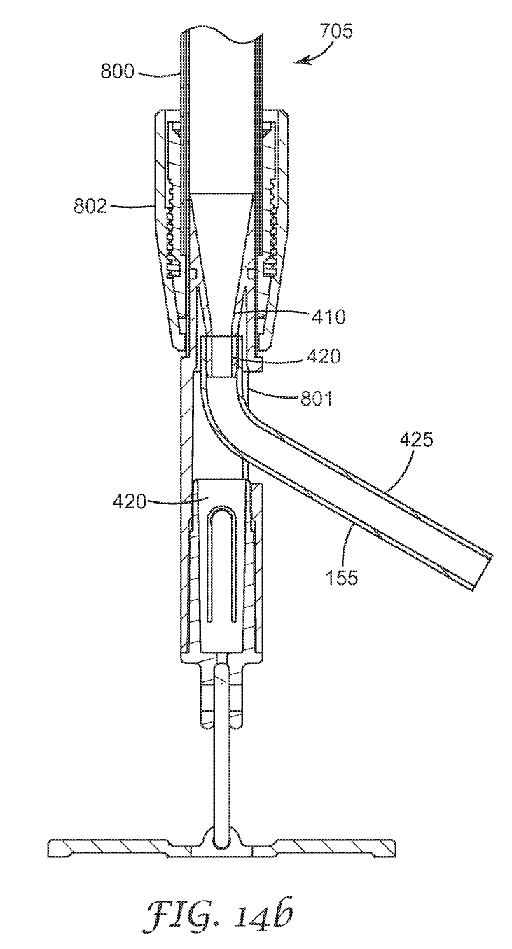

As used herein, the term “mop handle” has its commonly understood definition: an elongate member having a first, proximal or lower end adjacent a mop head and a second, distal or upper end opposite the lower end. In some embodiments, the handle may have an aspect ratio, that is, length to width ratio, of about 10:1 or greater. For many hand-held implements, a typical handle cross-section width dimension is in the range of about 0.75 inch to about 1.5 inch (about 18 mm to about 38 mm). Similarly, the handle length may be about 20 inches to 60 inches or more depending on the intended utility of the implement. The mop handle can be of a set length or adjustable in length. An embodiment of a telescoping adjustable length handle is shown in FIGS. 14a and 14b and described in greater detail below.

The “mop head” 190 is depicted in FIG. 1 as a substantially flat or platen media holder but may be any other suitable structure. The mop head is the portion of the mop assembly or similar cleaning implement adapted to attach a cleaning media (not shown) such as woven or nonwoven fabric or paper media as used in so-called flat mops; braided, twisted or woven textile strings or strips of fabric as used in so-called string or strip mops; squeegees, and various brush-like materials useful for cleaning or scrubbing floors and other surfaces. The mop head 190 may be attached to the lower end of the mop handle 140 by means of a coupling joint 170 that may provide a fixed union, thereby holding the mop head in a fixed orientation with respect to the mop handle or, alternatively, may provide a swiveling union, thereby permitting the mop head to remain attached to the mop handle yet assume more than one orientation with respect to the handle.

As used herein, terms such as “lower,” “bottom,” “below” and “down” denote a relative position nearer or toward the mop head or floor. Terms such as “upper,” “up,” “above” and “top” denote a relative position further or away from the mop head. It is to be understood that the description of the instant disclosure is made in terms of a mop for convenience and understandability of the description. It is fully contemplated by the inventor that the scope of the invention is not limited to use on a floor mop, but applies to other implements useful for cleaning surfaces or spreading or otherwise applying fluids to a surface including cleaning tools intended for use, for example, on floors, walls, sinks, toilets, windows, etc. In other words, the term mop is used herein to refer to any implement that includes a cleaning material fastened to a handle that can be used to clean any surface.

In a typical use mode, a mop is a two-handed cleaning implement. The operator, that is, the person using the mop, holds the mop with one hand grasping the handle towards its upper end and the other hand grasping the handle more towards its midpoint. With one hand, the operator applies pressure against the handle in such a way as to cause the mop head to swing about in an arc or figure eight pattern in front of the operator. The hand positioned nearer the midpoint of the handle provides much of the manipulation of the mop to cause the mop head to move about on the floor while the hand positioned near the upper end of the handle tends to stabilize the mop handle and create a non-stationary pivot point about which the upper end of the mop handle pivots during use.

Applicant has discovered that a reservoir attached at or near the pivot point of the handle does not substantially contribute to the inertia of the mop and, therefore, does not significantly impede the motion of the mop during use. Furthermore, a reservoir assembly disposed in coaxial alignment with and disposed at the upper end of the mop handle may serve as an extension to the handle itself, thereby permitting the hand at the upper end of the handle to simultaneously stabilize the mop motion and manipulate the reservoir to conveniently effect fluid dispense therefrom.

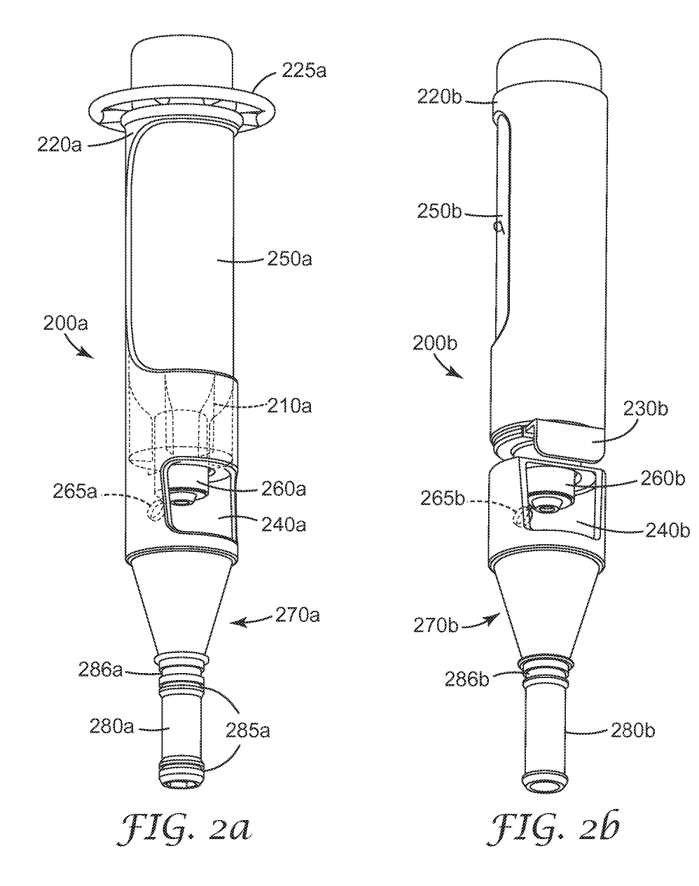

FIGS. 2a and 2b depict embodiments of the reservoir assembly 110 depicted in FIG. 1 in which a reservoir holder 200 is adapted to receive a reservoir 250 (when reference is made herein to items in FIG. 2 without specifying an “a” or “b”, then it applies to both embodiments). In these embodiments, the reservoir 250 comprises a deformable bottle having a cap 260 and a lid 265, the lid having an open position and a closed position. For convenience, the lid 265 may be attached to the cap 260 by a hinge, for example, to prevent loss or misplacement of the cap 260 during use. With the lid 265 in a closed position, no substantial fluid leakage will occur with the reservoir 250 in an upside down position even if the deformable reservoir is compressed, for example, as a result of being squeezed by hand. The lid 265 may be opened or closed conveniently while the reservoir 250 is disposed within the reservoir holder 200 by means of a cap aperture 240 in the holder 200. In some embodiments, the bottle is constructed of a see-through material that enables an operator to visually determine the amount of liquid within the bottle.

The reservoir 250 comprises an exit orifice that preferably contains a valve to permit fluid to flow therethrough when external pressure, such as by squeezing the reservoir, is applied to an outer surface of the reservoir and to prevent fluid flow absent such pressure. In a preferred embodiment, the cap 260 comprises the exit orifice and valve. A preferable valve is known to those of skill in the art as a bifurcating valve, that is, a valve that dispenses during the “squeeze” and prevents fluid flow otherwise. A bottle cap containing a bifurcating valve may be obtained from Liquid Molding Systems, Inc., Midland, Mich. Preferable reservoir capacity is about 250 ml to 1000 ml. Bottles of this size may be prefilled and carried by the operator to permit facile replenishment of the fluid for the mop once the currently used reservoir is empty.

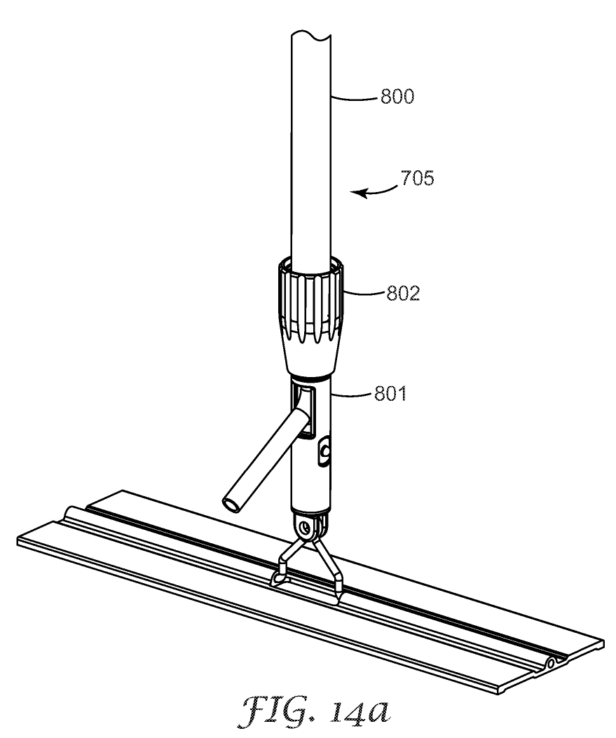

The reservoir is not limited to a bottle. Preferred reservoirs include any deformable or squeezable container adapted to hold fluid. For example, a suitable reservoir may comprise a bag or pouch with the reservoir holder being adapted to contain the reservoir and dispense fluid therefrom as exemplified by a bag-in-a-box container. A reservoir may comprise more than one chamber, thereby permitting the contents of multiple chambers to react, combine or mix prior to or during dispense. A system for maintaining a floor or other surface may comprise one or more of a mop assembly; one or more reservoirs; a carrier for additional reservoir(s); and a holster adapted to carry one or more reservoirs, the holster adapted to be worn on the body of the operator. A holster for carrying bottles is shown in FIG. 13 and described in greater detail below.

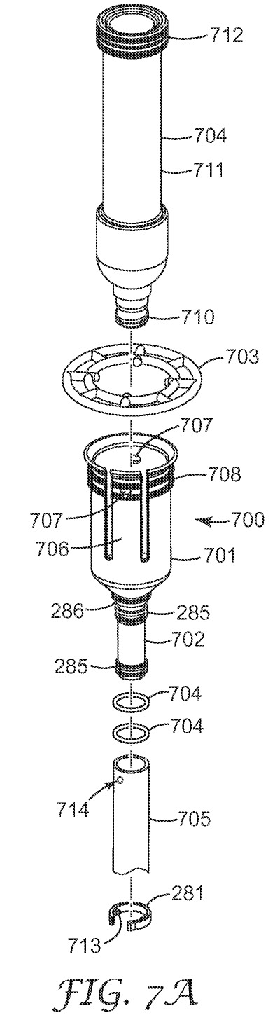

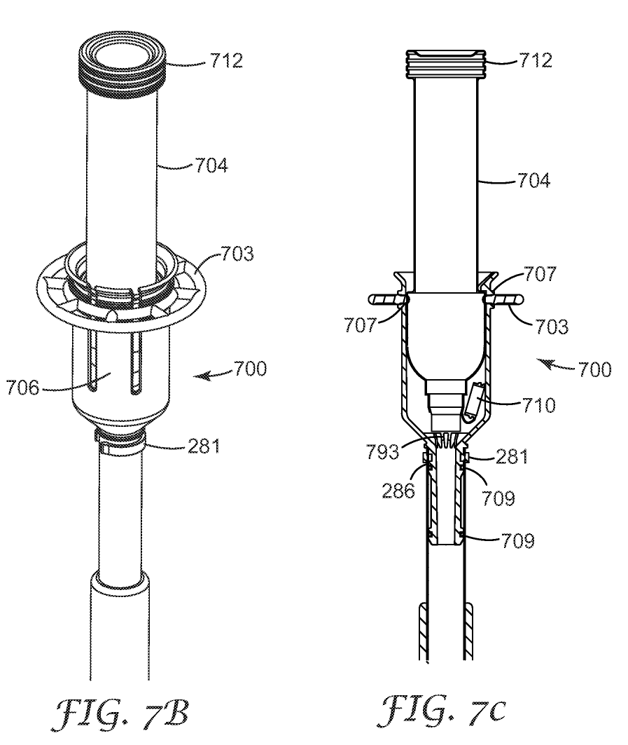

The reservoir holder 200 may comprise one or more reservoir support structures to permit proper positioning of the reservoir 250 within the holder 200. For example, a lower reservoir support 210a depicted in FIG. 2a may comprise a narrowing portion or other structure within the holder 200a, the narrowing portion or other structure being sufficient to engage and thereby to maintain a desired position of the reservoir 250a within the holder 200a. The lower reservoir support 210a may also engage the reservoir 250a by means of an interaction between one or more structures on the reservoir 250a with one or more structures on the holder 200a. An upper reservoir support 220a may act by itself or in concert with the lower support 210a to engage and thereby to maintain a desired position of the reservoir 250a within the holder 200a. In use upper reservoir support 220a can rest within the palm of an operator's hand while the fingers of the operator rest across the bottle. An upper reservoir support 220a depicted in FIG. 2a shows an embodiment of a reservoir support in which reservoir holder 200a includes a bumper 225a that comprises two concentric circles in a hub-and-spoke type arrangement and which may be adapted to receive O-rings (not shown). In one embodiment, the upper reservoir support 220 includes, for example, a slotted channel (not shown) such that a portion of the inner O-ring makes frictional contact with the reservoir 250a. In an alternative embodiment shown in FIGS. 7a-c and described in greater detail below, the O-ring may include boss that that protrude inwardly. The bosses are configured to extend through apertures 707 to frictionally engage the bottle.

The reservoir holder 200 shown in FIGS. 2a and 2b may be adapted by its own shape, by additional fittings or moldings, or by attached external devices to rest securely when the mop handle is placed in an upright position against a wall, pillar, post or other generally vertical surface (referred to as “wall” hereinafter). Thus, the reservoir holder may comprise a planar portion such as a flat edge or a rectangular cross-section, for example, at or adjacent its upper end. Alternatively, one or more suitable projections or “feet” may be formed on the reservoir holder to provide stable resting means. A bumper 225a may be disposed at or near the upper end of the mop handle to permit the mop to rest securely against a wall when the handle is positioned in an upright manner. An example of a bumper is a thick O-ring.

A commonly known O-ring comprises a unitary circular filament of rubber or other material, the O-ring having an inside diameter and an outside diameter, and the filament having a thickness defined as the difference between the outside radius and the inside radius of the O-ring. When a reservoir assembly is disposed at the upper end and in coaxial alignment with the handle, for example, a bumper 225a may be disposed in the slotted channel. In the example of FIG. 2a, a preferable O-ring has an inside diameter sufficient to provide frictional contact with the reservoir 250a as described above and at the same time has an outside diameter sufficient to provide frictional contact with a wall when the mop assembly is disposed in an upright manner against the wall. The O-ring filament typically has a circular cross-section, but an O-ring suitable for the purposes described herein may advantageously have other cross-sections such as rectangular or hexagonal, for example. A suitable O-ring may also comprise more than one O-ring disposed concentrically and attached to each other by means of spokes or radii wherein the innermost O-ring provides frictional contact with the reservoir and the outermost O-ring provides frictional contact with the wall when the mop assembly is disposed in an upright manner against the wall. In addition to providing stable resting means when the mop assembly is disposed in an upright manner against the wall, a thick O-ring or concentric O-ring assembly as described above may also act as a bumper to help prevent damage to the reservoir holder assembly if the mop handle falls to the floor. Depending on the disposition of the reservoir with respect to the handle, a bumper may be attached or formed directly onto or adjacent the upper end of the handle itself.

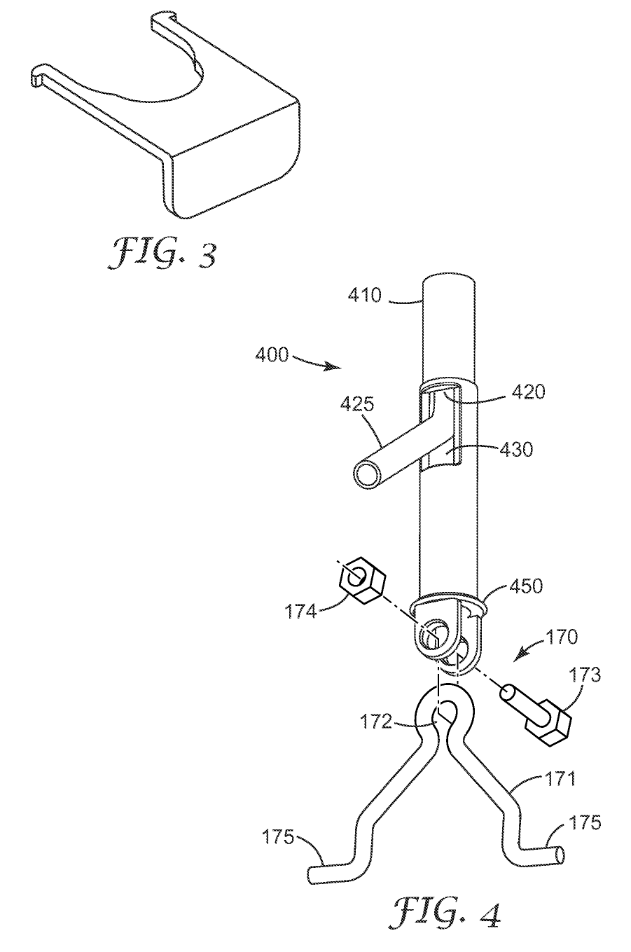

In an alternative embodiment, shown in FIG. 2b, the reservoir holder 200b, may be a locking tab 230b, which can be pressed forward to hold the bottle in place and can be pulled rearward to release the bottle from the reservoir holder 200b. A detailed view of the locking tab is shown in FIG. 3.

Referring generally to FIGS. 2a and 2b, the reservoir holder 200 includes an adapter for attaching the holder 200 to a mop handle. In the embodiment depicted, the holder 200 is adapted at its lower end 270 to engage a tubular hollow mop handle 140 (see, for example, FIGS. 1, 7a, and 7c) and to provide fluid communication between the reservoir 250 and the hollow handle. A handle adapter 280 may comprise one or more channels or grooves 285 adapted to receive an O-ring 281, thereby permitting a secure, leak-proof engagement between an inner portion of the hollow handle 140 and the adapter 280. The handle adapter 280 may further comprise one or more slots, grooves or channels 286 corresponding to slots in an upper portion of the hollow handle, thereby permitting securing of the handle adapter 280 to the handle by means of snap rings 281, screws or other attachment means (see, for example, FIGS. 7a-c).

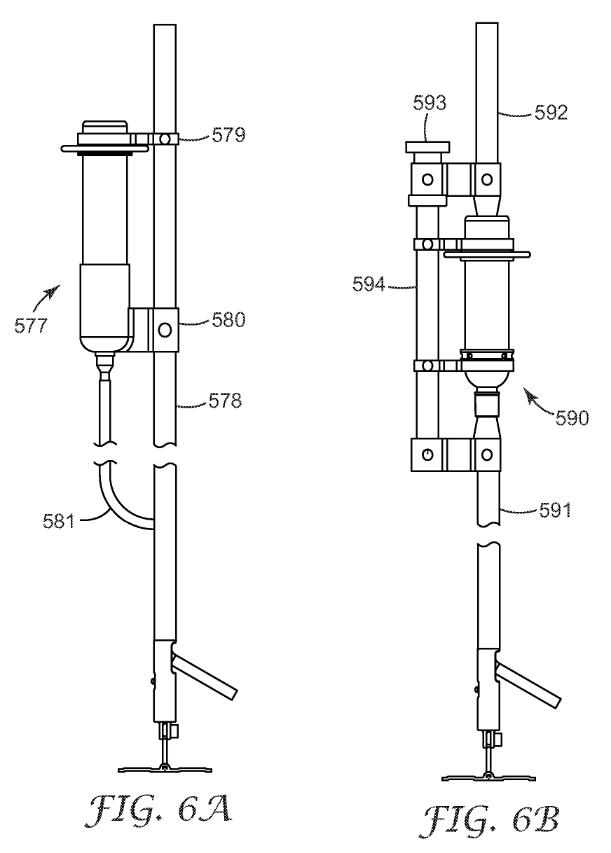

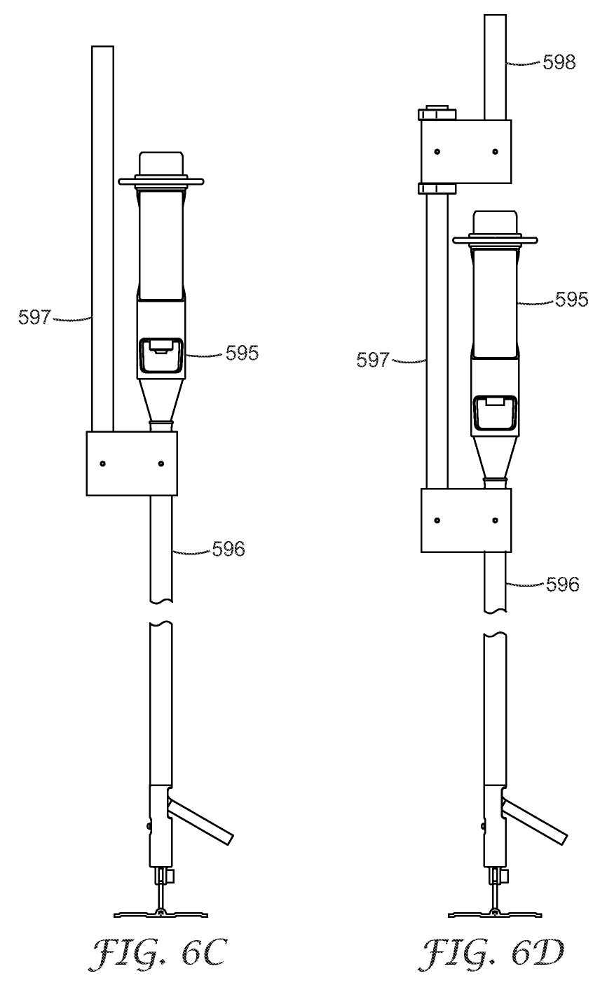

The handle 140 can be hollow as illustrated in the figures or, alternatively, non-hollow, that is, a more conventional solid handle. If the handle is solid the reservoir holder may be attached or otherwise secured to the upper end of the handle by means of screws, clamps, straps or any other attachment means. Several alternative attachment means are shown in FIGS. 6a-6d and will be described in greater detail below. Preferably, the reservoir holder is disposed on the handle in such a way that the reservoir itself may be manipulated by the operator to effect release of fluid contained therein. The reservoir holder 200 may be formed in one piece by machining or molding, for example, or other processes known to those of skill in the art. The reservoir holder 200 may be removably attached to the handle as shown in the figures and described above or may be an integral part of the handle.

For ease of manufacture, reservoir holder 200 will preferably comprise two or more segments which can then be fit together to make the whole. Depending on the materials used to manufacture the holder, the segments may be joined together by commonly known methods such as conventional welding or solvent welding or by means of a suitable adhesive. Alternatively, the segments may be adapted with appropriate mating surfaces so they may be screwed together or joined by friction fit. The segments may also comprise corresponding slots, channels or grooves to permit assembly of the segments into the whole by means of screws, rivets, snap rings and the like.

Referring once again to FIG. 1, the mop handle 140 may comprise a relatively rigid material such as wood, plastic or metal. The handle may have a bore or interior passage therethrough, the bore or passage being coaxial with the long axis of the handle, thereby creating a channel within that portion of the handle with which to convey fluid from the reservoir towards the lower end of the handle.

The handle may comprise a unitary structure or, alternatively, may comprise two or more sections which interengage with each other such as by telescoping, friction fit, screwing together, and the like. In addition to providing means for operator manipulation of the mop head 190 on the floor, the mop handle 140 in the instant disclosure is in fluid communication with the reservoir assembly 110 and provides conveyance of the fluid dispensed by the fluid reservoir 130 from the reservoir to the floor. Though in the depicted embodiment the handle acts as the fluid conduit, in alternative embodiments the handle could merely house a tube which conveys the fluid from the reservoir 110 to the mop head 190. In a hollow handle, conveyance may be through the interior of the handle with fluid communication between the handle 140 and the reservoir assembly 110 being established by means of, for example, the handle adapter 280 depicted in FIG. 2. In a solid handle, conveyance may be by means of tubing, channel(s) or other conveyance means extending down at least a portion of the length of the handle within or exterior to the handle with fluid communication between the handle and the reservoir assembly being established by means of, for example, a tubing connector on the reservoir assembly. See, for example, FIG. 6a.

Fluid thus conveyed from the fluid reservoir by means of the mop handle is dispensed onto the surface proximal to the mop head. If the conveyance means comprises tubing, channel(s) and the like, the lower end of the tubing, channel(s), etc., may conveniently be disposed to permit flow of the liquid onto the floor in proximity to the mop head or onto the mop head itself. If the conveyance means comprises a hollow handle or a handle having a bore therethrough, an adapter may be used to convey the fluid from an interior portion to an exterior portion of the handle. It is also contemplated for some embodiments of the instant disclosure that fluid may be dispensed directly through the air onto the surface from the reservoir without use of particular conveyance means.

FIG. 4 depicts an exemplary fluid outlet adapter 400. The upper end 410 of outlet adapter 400 is adapted to attach to the lower end of the handle (see FIG. 1) and provide fluid communication with a lower portion of the handle. In this embodiment of an outlet adapter, fluid is conveyed through a bore within the interior of the adapter and communicating with a nipple 420. The nipple 420 may be configured to dispense the fluid directly onto the floor. Alternatively, a dispense tube 425 may provide conveyance of the fluid between the nipple 420 and the floor surface. In FIG. 4, the dispense tube 425 is shown disposed within a cavity or aperture 430 within the outlet adapter 400 and attached to an exterior portion of nipple 420, thereby providing fluid communication between an interior portion of the adapter and an exterior portion of the mop assembly. The nipple or dispense tube may be adapted to provide one or more streams of liquid or foam, or a spray of fluid onto the floor surface or mop head.

The outlet adapter 400 of FIG. 4 is shown with a coupling adapter 450. A coupling adapter may enable attachment of the fluid dispense assembly 150 of FIG. 1 to the mop head 190 by means of a coupling joint 170. In the depicted embodiment the coupling joint 170 includes a bent metal piece 171 that includes a keyhole portion 172 that is configured to receive a bolt 173, which together with a nut 174 pivotally connects the bent metal piece 171 to the coupling adapter 450. The lower ends 175 can be pivotally connected to the media holder or mop head 190. The arrangement shown enables the mop head to pivot about two perpendicular axes relative to the handle. In some embodiments the coupling adapter allows rotation about the longitudinal axis of the handle as well.

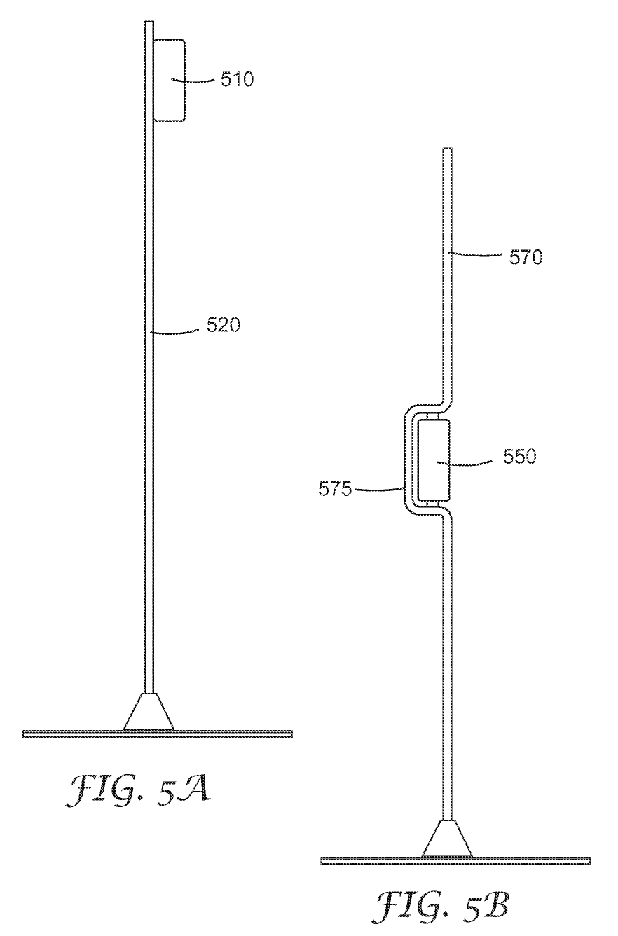

In another aspect of the present disclosure, a reservoir assembly comprising a reservoir may be disposed adjacent the mop handle in such a way as to permit the operator to grasp at least a portion of the reservoir and handle simultaneously, thereby permitting dispense of the fluid from the reservoir by hand actuation while manipulating the mop in a typical use mode. FIG. 5a depicts an embodiment of the disclosure in which a reservoir 510 is disposed adjacent the upper end and parallel to the long axis of the mop handle 520, the reservoir being in fluid communication with the floor as described hereinabove, and the reservoir 510 being disposed on the handle 520 so as to permit the operator to grasp at least a portion of the reservoir and handle simultaneously. With the reservoir disposed as shown in FIG. 5a, the operator is expected to grasp and actuate the reservoir with the uppermost hand when the mop is being used in a typical use mode.

FIG. 5b depicts another embodiment contemplated by Applicant in which a reservoir 550 is disposed adjacent the handle 570 in a portion of the handle 575 adapted to receive the reservoir. In both FIGS. 5a and 5b, details of the reservoir assembly, reservoir attaching means and fluid conveyance means, generally similar in concept to those described hereinabove or generally known to those of skill in the manufacturing arts, have been omitted.

The reservoir or reservoir assembly may be removably attached to the handle. The reservoir may be refillable from an external source of fluid. One method of use contemplated by Applicant comprises filling one or more reservoirs with the same or different cleaning fluids, loading a reservoir into the reservoir holder on the mop handle, grasping the mop handle to begin the mopping procedure and simultaneously actuating the reservoir to release a portion of the cleaning fluid. An advantage of the present inventive liquid dispensing mop assembly is that an immediate change of cleaning fluid may be effected merely by removing the current reservoir and inserting a new one. Thus, the operator may clean a floor surface using a first reservoir containing a general purpose cleaner, remove the first reservoir, and insert a second reservoir containing a disinfectant fluid and proceed to mop the floor with disinfectant without having to empty the first reservoir. FIG. 13 depicts a holster 600 that can be attached around the waist to provide a convenient means of carrying a number of bottles. The holster 600 includes two packs 602 and 604 connected by a strap 610. Each pack includes three mesh pouches 606 that are sized to receive bottles of cleaning liquid. The ends of the strap 610 are connected via a slide release buckle 608, which enables an operator to quickly and easily attach and detach the holster 600. It should be appreciated that many alternative holster arrangements are possible.

Referring to FIGS. 6a-6d, four exemplary alternative embodiments of bottles and shaft configurations are shown. FIG. 6a depicts a reservoir holder and bottle arrangement 577 attached adjacent to the shaft 578 via mounting brackets 579 and 580. In the depicted embodiment fluid flows from the bottle through a tube 581 that is partially external to the shaft 578. FIG. 6b depicts a reservoir holder and bottle arrangement 590 that is axially aligned with the main shaft 591. The shaft 591 jogs around the reservoir and bottle arrangement 590. The upper portion of the shaft 592 can be pivoted aside to enable loading and unloading of bottles from the reservoir holder by locking and unlocking the locking mechanism 593 on the off axis portion 594 of the shaft, FIG. 6c depicts another embodiment where the reservoir holder and bottle arrangement 595 is aligned with the main shaft portion 596. In the depicted embodiment an off axis portion of the shaft 597 is arranged along the reservoir holder and bottle arrangement 595 to provide another area for the operator to grab unto while cleaning. The embodiment shown in FIG. 6d is similar to the embodiment shown in 6c. It differs only in that it includes an upper portion 598 that is aligned with the main shaft 596. This embodiment is also similar to the embodiment depicted in 6b, but there is sufficient space between the bottom of the upper portion 598 and the reservoir holder and bottle arrangement 595 to enable bottles to be loaded and unloaded without moving the upper portion 598.

Referring to FIGS. 7a-7c, views of a third alternative embodiment of the reservoir holder and bottle of FIG. 1 are shown. The reservoir holder 700 includes a main body portion 701, a neck 702, and a bumper 703. The main body portion 701 is sized and configured to receive and support a bottle 704 and the neck 702 is configured to be received and supported by the shaft 705. The bumper 703 is seated in groove 708 on the outer surface of the body portion 701 to bias the tab 706 of the body portion 701 radially inward. The tab 706 includes a ridge on its inside surface that engages the annular shoulder disposed on the lower portion of the bottle 704. The ridge snaps over the shoulder to help hold the bottle 704 within the reservoir holder 700. In the depicted embodiment the bumper includes bosses that protrudes through apertures 707 in the body portion 701 and directly engages the outer surface of the bottle 704. As discussed above, the depicted bumper 703 is also constructed to extend away from the reservoir holder 700 to protect the reservoir holder 700 from damage that could result from the device falling to the floor.

In the depicted embodiment, the bottle 704 includes a lower portion that has a cap 710 that opens prior to inserting the bottle 704 into the body portion 701 of the reservoir holder 700. When the cap is open as shown in FIG. 7c the bottle dispenses liquid when squeezed. The bottle 704 is shown to include a mid-section 711 that is sized to be grasped by an operator's hand. The end portion 712 includes ribs for added structural rigidity. In the depicted embodiment the neck 702 is similar to the neck shown in FIG. 2a. The neck 702 supports the main body portion 701 on the shaft 705 and funnels the liquid dispensed from the bottle 704 into the shaft 705. The radial web-like features 793 support the lower end of the bottle 704 yet allow fluid to flow from the bottle 704 into the neck 702.

The neck 702 includes a pair of spaced apart grooves that are sized to receive a pair of O-rings 709. The O-rings 709 interface between the neck 702 and the inside surface of the shaft 705. The O-rings 709 seal the connection between the neck 702 and shaft 705 and provide a snug fit between the two components, which eliminates undesirable rattling and play between neck 702 and the shaft 705.

The snap ring 281 in the depicted embodiment locks the shaft 705 to the neck 702. The snap ring 281 includes a projection 713 that fits through an aperture 714 on the shaft 705 and extends into a radial slot 286 on the neck 702. The reservoir holder 700 can be detached from the shaft by removing the snap ring 281. It should be appreciated that the above-described neck 702 and shaft 705 arrangement is only one of many ways to connect the reservoir holder 700 to the shaft 705.

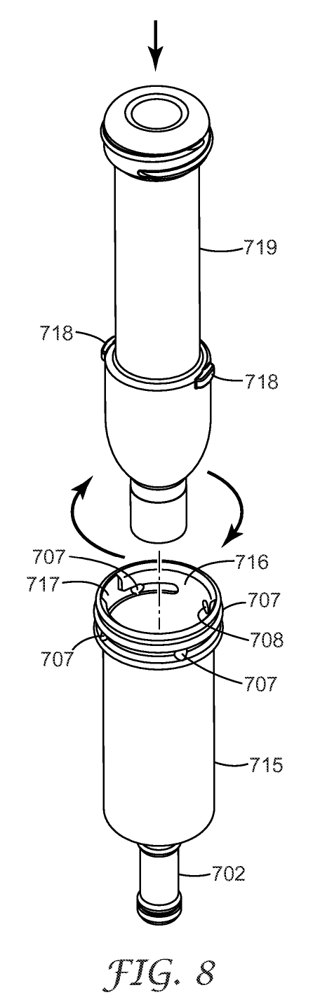

Referring to FIG. 8, an exploded view of a fourth embodiment of the reservoir holder of FIG. 1 is shown. This embodiment is generally similar to the embodiment shown in FIGS. 7a-c, however, the body portion 715 does not include the tab 706. The embodiment shown in FIG. 8 includes the groove 708 and aperture 707 for receiving the bumper 703 shown in FIGS. 7a-c. In the depicted embodiment the inside upper edge 716 of the body portion 715 includes an L-shaped groove 717 that is sized to receive protrusions 718 on the bottle 719. The bottle 719 can be secured into the body portion 715 by engaging the protrusions 718 with the groove 717 and twisting the bottle 719 clockwise. The bottle 719 can be released by twisting the bottle 719 counter clockwise and pulling it away from the body portion 715 of the holder. In the depicted embodiment the neck 702 is identical to the neck 702 of the embodiment shown in FIGS. 7a-c.

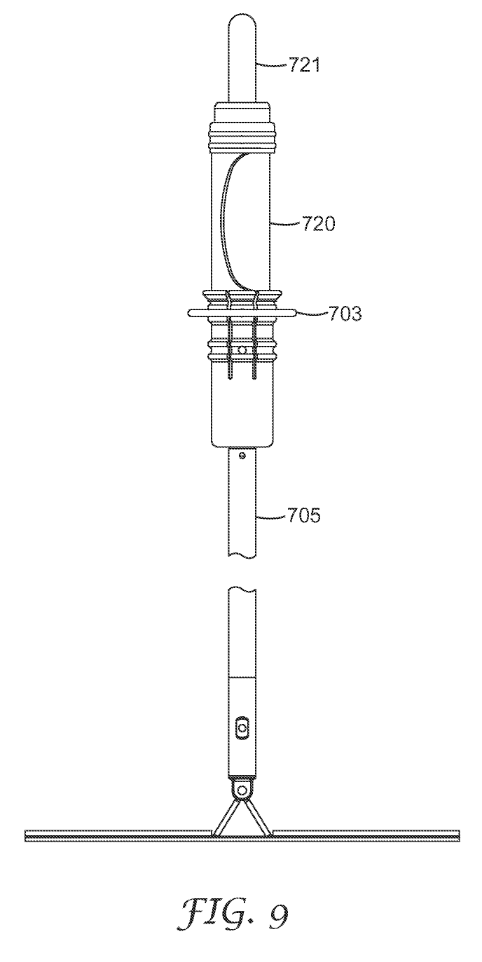

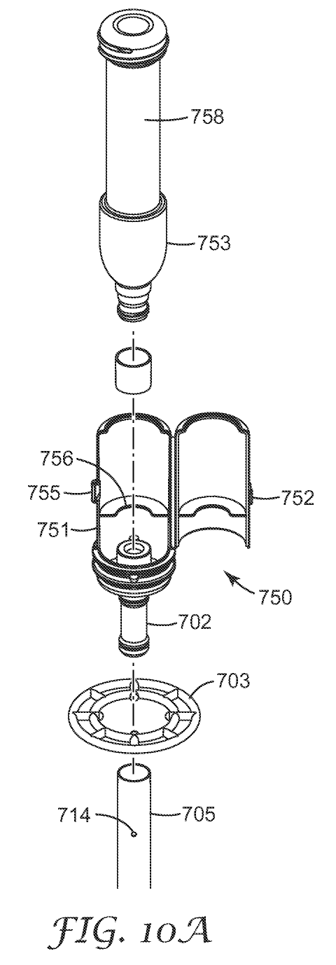

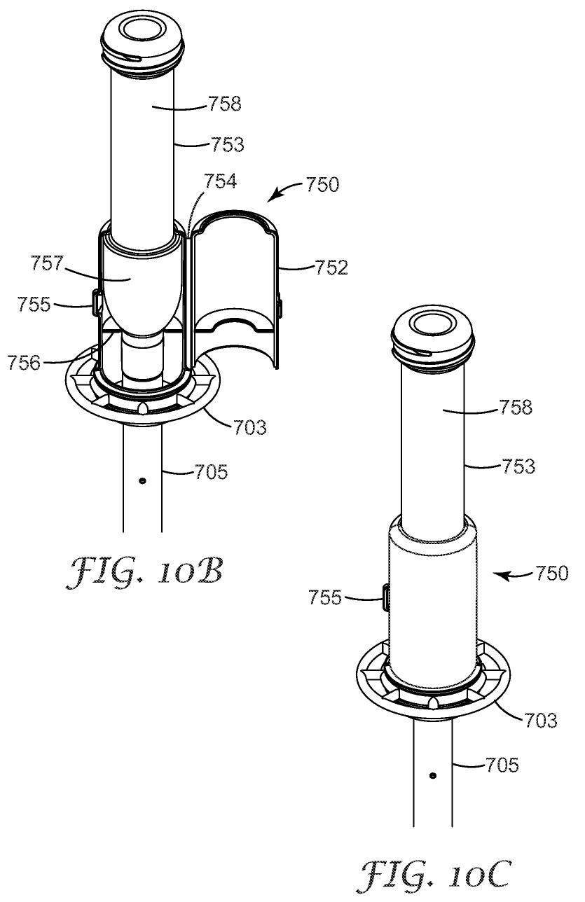

FIG. 9 is a perspective view of an alternative embodiment of the bottle of FIG. 1. The depicted embodiment is similar to the embodiment shown in FIGS. 7a-c. However, the bottle 720 has a different shape and a handle extender 721 is shown. The bottle 720 includes a threads on the upper end (see, for example, FIGS. 10a-c) that are constructed to mate with the handle extender 721 that threads unto and extends vertically from the upper end of the bottle 702. The handle extender 721 provides yet another location for the operator to hold onto to manipulate the cleaning device when the operator does not want to dispense liquid from the bottle 720.

Referring to FIGS. 10a-c, views of a fifth embodiment of the reservoir holder of FIG. 1 are shown. In the depicted embodiment the body portion 751 of reservoir holder 750 includes a door 752 that can be opened to load and unload a bottle 753 and closed to secure the bottle 753 therein. In the depicted embodiment the door 752 opens along a living hinge 754 and snaps close via a locking mechanism 755. The body portion 751 includes an internal structural member 756 that ensures that the bottle 753 is securely held when the door 752 is closed. In the depicted embodiment, only the lower portion 757 of the bottle 753 is housed within the body portion 751 of the reservoir holder 750. The upper portion 758 is left exposed so that the operator can squeeze the bottle 753 to dispense liquid.

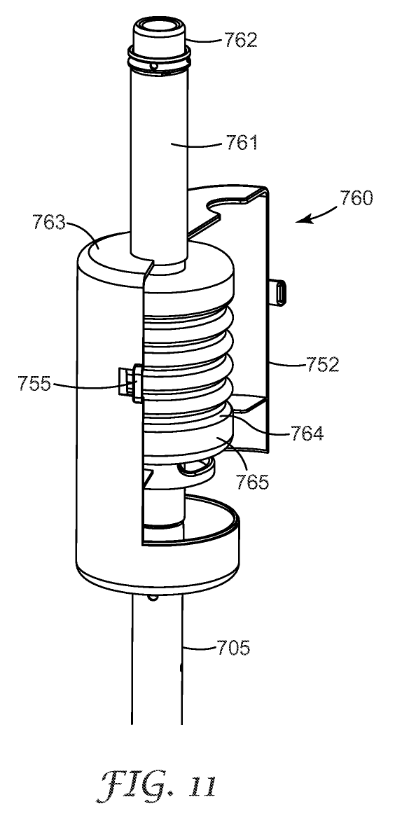

Referring to FIG. 11, a perspective view of a sixth embodiment of the reservoir holder and bottle of FIG. 1 is shown. The depicted embodiment is similar to the embodiments shown in FIGS. 10a-c in that the embodiment includes a door. However, in the depicted embodiment the reservoir holder 760 includes a plunger support structure and a plunger 762. The plunger is received within an aperture 763 in the reservoir holder 760 and extends into the body of the reservoir holder 760. The bottle 765 within the reservoir holder 760 is configured with radial ribs 764 that enable it to be compressed downward via the plunger 762. According to the depicted embodiment depressing the plunger 762 dispenses liquid from the bottle 765.

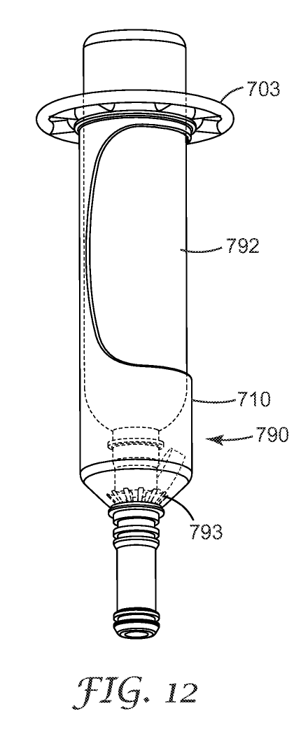

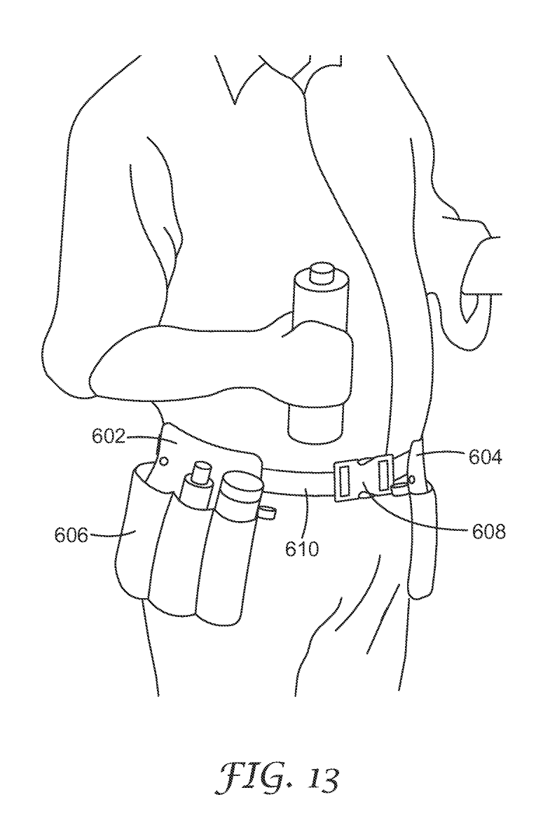

FIG. 12 is a perspective view of a seventh embodiment of the reservoir holder and bottle of FIG. 1. This embodiment is similar to the embodiment depicted in FIG. 2a. However, the reservoir holder 790 does not include a window or cap aperture 240. In the embodiment shown the bottle cap 710 is open before the bottle 792 is seated within the holder 790. The neck and bumper of the reservoir holder 790 are similar to the neck and bumpers described above.

FIGS. 14a and 14b are perspective views of a telescoping shaft according to the disclosure. The shaft 705 includes an upper portion 800 and a lower portion 801. The lower portion 801 telescopes from the upper portion 800. Mounted on the upper portion is a locking mechanism 802 that can be disengaged to allow the upper portion 800 and lower portion 801 to move relative to each other, and engaged to lock the upper portion 800 and lower portion 801 in a fixed position. In the depicted embodiment the inside of the shaft 705 acts as a fluid conduit. In other words the shaft 705 is constructed such that liquid flows directly through the inside of the shaft 705. In the depicted embodiment sealing O-rings are used to seal the connection between the upper and lower portions to prevent fluid from leaking out of the shaft 705. It should be appreciated that many alternative embodiments of the shaft 705 are possible.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A floor mop assembly for cleaning a surface, the floor mop assembly comprising:
a handle having a lower end and an upper end;
a media holder attached to the lower end of the handle; and,
a reservoir disposed on or adjacent the upper end of the handle,
wherein the reservoir is adapted for containing a fluid and dispensing fluid therefrom.

2. The floor mop assembly of claim 1, wherein the center of gravity of the reservoir is proximal the upper end of the handle.

3. The floor mop assembly of claim 1, wherein the reservoir comprises a squeeze bottle having an exit orifice through which fluid can flow out of the bottle.

4. The floor mop assembly of claim 3, wherein the exit orifice comprises a valve.

5. The floor mop assembly of claim 4, wherein the exit orifice comprises a bifurcating valve.

6. The floor mop assembly of claim 1, wherein the reservoir comprises an adapter constructed to releasably attach the reservoir to the handle.

7. The floor mop assembly of claim 1, further comprising a fluid dispensing outlet attached to the handle configured to dispense liquid to the mop head.

8. The floor mop assembly of claim 7, wherein the handle comprises an interior passage adapted to receive fluid from the reservoir and convey the fluid to the dispensing outlet.

9. The floor mop assembly of claim 3, wherein the squeeze bottle comprises a see-through material that allows a user to determine the level of fluid contained within the bottle.

10. The floor mop assembly of claim 7, further comprising a tube connected to the reservoir, wherein the tube receives fluid from the reservoir and dispenses the fluid on the floor through the dispensing outlet.

11. A liquid dispensing cleaning apparatus comprising:
a handle having a first end portion and a second end portion, wherein the handle is telescoping and comprises an internal fluid conduit;
a bottle holder attached to the first end portion of the handle, the bottle holder constructed to place the bottle in fluid communication with the fluid conduit;
a fluid dispenser located at the second end portion of the handle, the fluid dispenser constructed to enable fluid to exit the fluid conduit.

12. The cleaning apparatus according to claim 11, wherein the bottle holder includes a neck that extends into a first end of the handle.

13. The cleaning apparatus according to claim 12, wherein the neck includes two spaced apart concentric grooves that engage O-rings, wherein the O-rings contact the neck and an inside surface of the handle.

14. The cleaning apparatus according to claim 12, wherein the neck includes a recess that engages a snap ring that releasably locks the bottle holder to the handle.

15. The cleaning apparatus according to claim 11, wherein the bottle holder is configured to support a bottle such that the bottle is aligned with a longitudinal axis of the handle.

16. The cleaning apparatus according to claim 11, wherein the bottle holder is configured to support the bottle such that the bottle can be squeezed by the hand of an operator while the bottle is in the bottle holder.

17. The cleaning apparatus according to claim 11, wherein the bottle holder includes a door that can be opened to enable a bottle to be inserted therein and closed to secure the bottle within the bottle holder.

18. The cleaning apparatus according to claim 17, wherein a portion of the bottle within the bottle holder can be compressed by actuating a plunger that extends from the bottle holder.

19. The cleaning apparatus according to claim 11, wherein the bottle holder is constructed such that axially twisting a bottle in a first direction secures the bottle within the bottle holder and twisting the bottle in the reverse direction releases the bottle from the bottle holder.

20. The cleaning apparatus according to claim 11, wherein the bottle holder is configured to receive an O-ring at least partially positioned around the bottle holder, wherein the O-ring is configured to frictionally engage a bottle within the bottle holder.

21. The method of cleaning comprising the steps of:
holding a mop with a first hand around the shaft of a handle and a second hand around a bottle attached to the handle;
squeezing the bottle to dispense liquid from the bottle through the handle of a mop onto a floor surface as desired.

22. The method of cleaning according to claim 21, including the step of carrying a plurality of bottles in a holster, wherein the holster is configured to support bottles vertically around the waist of an operator.

23. The method of cleaning according to claim 21, wherein the step of squeezing the bottle is simultaneous while the mop is moved across the surface to be cleaned.

24. The method of cleaning according to claim 21, further comprising the step of opening a cap on the bottle prior to inserting the bottle into a bottle holder that is connected to the shaft of the mop.

25. The method of cleaning according to claim 21, further comprising adjusting the length of the handle.

26. A liquid dispensing cleaning system comprising:
a handle include a first end and a second end, the handle including a fluid conduit therein;
a media holder pivotally connected to the first end of the handle;
a dispenser in fluid communication with the fluid conduit, the dispenser located adjacent the first end of the handle;
a bottle holder axially aligned with and connected to the second end of the handle;
a squeeze bottle including a first end portion and a second end portion, the first end portion of the bottle being held within the bottle holder;
wherein the bottle is in fluid communication with the fluid conduit and dispenser and configured such that squeezing the bottle results in liquid flowing from the bottle through the fluid conduit and out the dispenser.

27. The system according to claim 26, wherein the handle includes a hollow telescoping construction.

28. The system according to claim 26, further comprising a harness that can be worn by the operator, the harness including a plurality of pouches configured to retain bottles.

29. The system according to claim 26, wherein the bottle holder includes a quick connect assembly for attaching and detaching the bottle holder from the handle.

30. The system according to claim 26, wherein the squeeze bottle is frictionally fit within the bottle holder.

31. The system according to claim 26, further comprises an actuator that presses against the squeeze bottle to deform the bottle and thereby dispense liquid from the bottle.
